(19) United States
(12) Patent Application Publication
(10) Pub. No.: US 2026/0371413 A1
(43) Pub. Date: Nov. 19, 2026

(54) ELECTRONIC DEVICE FOR CHANGING THRESHOLD VALUE OF QUALITY FOR CONNECTING VIA SHORT-RANGE WIRELESS COMMUNICATION AND METHOD FOR OPERATING SAME

(71) Applicant: SAMSUNG ELECTRONICS CO., LTD., Suwon-si (KR)

(72) Inventors: Insick JUNG, Suwon-si (KR); Jeongki PARK, Suwon-si (KR); Soyun BANG, Suwon-si (KR); Changmok YANG, Suwon-si (KR); Yongjae YOO, Suwon-si (KR); Jusik YUN, Suwon-si (KR); Junsu CHOI, Suwon-si (KR); Jehyun HEO, Suwon-si (KR)

(73) Assignee: SAMSUNG ELECTRONICS CO., LTD., Suwon-si (KR)

(21) Appl. No.: 19/730,098

(22) Filed: Jul. 2, 2026

Related U.S. Application Data
(63) Continuation of application No. PCT/KR2026/097134, filed on May 19, 2026.

(30) Foreign Application Priority Data
May 19, 2025 (KR) 10-2025-0064876
Jun. 24, 2025 (KR) 10-2025-0083831
Jul. 17, 2025 (KR) 10-2025-0097012

(51) Int. Cl. H04W 76/10; H04B 17/318; H04L 61/103; H04L 61/5014; H04W 28/24; H04W 76/30

(52) U.S. Cl. CPC H04W 76/10; H04B 17/318; H04L 61/103; H04L 61/5014; H04W 28/24; H04W 76/30

(57) ABSTRACT

An electronic device to establish a Wi-Fi connection with an access point (AP) via the short-range wireless communication. The electronic device to transmit, to the AP, an address resolution protocol (ARP) request message, based on that a response message corresponding to the ARP request message is not received from the AP within a first defined time period, transmit, to the AP, a dynamic host configuration protocol (DHCP) request message for acquiring an Internet protocol (IP) address of the electronic device, and based on that a response message corresponding to the DHCP request message is not received from the AP within a second defined time period: release the Wi-Fi connection between the electronic device and the AP.

### CROSS-REFERENCE TO RELATED APPLICATIONS

This application is a continuation of International Application No. PCT/KR2026/097134, filed on May 19, 2026, which is based on and claims priority to Korean Patent Application No. 10-2025-0064876, filed on May 19, 2025, Korean Patent Application No. 10-2025-0083831, filed on Jun. 24, 2025, and Korean Patent Application No. 10-2025-0097012, filed on Jul. 17, 2025, in the Korean Ministry of Intellectual Property, the disclosures of which are incorporated by reference herein in their entireties.

### BACKGROUND

### 1. Field

The disclosure relates to an electronic device and a method of operating the electronic device and, more particularly, to an electronic device that changes a threshold value of quality for connecting via short-range wireless communication.

### 2. Description of Related Art

With the distribution of various electronic devices, the speed of wireless communications usable by various electronic devices has been improved. Among the wireless communications supported by recent electronic devices, the IEEE 802.11 WLAN (or Wi-Fi) is a standard for implementing high-speed wireless connectivity on various electronic devices. The first Wi-Fi implementation could support a maximum transmission speed of 1 to 9 Mbps, but the Wi-Fi 6 technology (or IEEE 802.11ax) is capable of supporting a maximum transmission speed of approximately 10 Gbps.

An electronic device may support various services (e.g., a ultra high definition (UHD) video streaming service, an augmented reality (AR) service, a virtual reality (VR) service, or a mixed reality (MR) service) using relatively large-capacity data via wireless communication supporting a high transmission rate, and may also support various other services.

In order to perform short-range wireless communication, the electronic device may be connected to an access point (AP) capable of providing short-range wireless communication via short-range wireless communication. An AP may manage one basic service set (BSS), and the electronic device included in the BSS may transmit and/or receive data via short-range wireless communication provided by the AP.

### SUMMARY

However, an electronic device may be a mobile electronic device, and a distance between the electronic device and an AP may change. When the electronic device moves in a direction away from the AP, a quality of a signal transmitted by the AP may decrease. When the decreased quality is less than or equal to a minimum value, the connection with the AP may be released.

As the electronic device moves away from the AP, the signal quality between a electronic device and the AP may remain unstable near a threshold value required for the connection, and thus a phenomenon in which the connection to the AP is repeatedly released and re-established may occur. The phenomenon in which the connection between the electronic device and an AP is repeatedly released and reconnected may cause an increase in power consumption of the electronic device and a deterioration in the quality of the short-range wireless communication.

In addition, an attempt by the electronic device to connect to an AP that is difficult to provide an appropriate quality of short-range wireless communication may cause a reduction in the quality of a service using the short-range wireless communication.

The technical problems to be solved in the disclosure are not limited to those described above, and other technical problems which are not described may be clearly understood from the following description by those skilled in the art to which the disclosure pertains.

An electronic device according to an example may include communication circuitry for performing short-range wireless communication. The electronic device may include memory for storing instructions. The electronic device may include at least one processor. The instructions, when executed by the at least one processor, may cause the electronic device to establish a Wi-Fi connection, via short-range wireless communication, with an access point (AP) based on the quality of a signal received from the AP being greater than or equal to a first threshold value representing a minimum value of quality required for connection via the short-range wireless communication. The instructions, when executed by the at least one processor, may cause the electronic device to transmit an address resolution protocol (ARP) request message to the AP after establishing the Wi-Fi connection to the AP. The instructions, when executed by the at least one processor, may cause the electronic device to transmit a dynamic host configuration protocol (DHCP) request message to the AP to acquire an internet protocol (IP) address of the electronic device, when a response message corresponding to the ARP request message is not received from the AP within a defined time. The instructions may, when executed by the at least one processor, cause the electronic device to, in a case where a response message corresponding to the DHCP request message is not received from the AP within a defined time, release the Wi-Fi connection between the electronic device and the AP, and refrain from establishing the Wi-Fi connection between the AP and the electronic device, based on the quality of a signal received from the AP being less than a second threshold value that is greater than the first threshold value.

In a recording medium storing at least one program including instructions which, when executed individually or collectively by at least one processor of an electronic device, cause the electronic device to perform operations, the instructions, when executed by the at least one processor, may cause the electronic device to establish a Wi-Fi connection, via short-range wireless communication, with an access point (AP) based on the quality of a signal received from the AP being greater than or equal to a threshold value representing a minimum value of quality required for connection via the short-range wireless communication. The instructions, when executed by the at least one processor, may cause the electronic device to transmit an address resolution protocol (ARP) request message to the AP after establishing the Wi-Fi connection to the AP. The instructions, when executed by the at least one processor, may cause the electronic device to transmit a dynamic host configuration protocol (DHCP) request message to the AP to acquire an internet protocol (IP) address of the electronic device, when a response message corresponding to the ARP request message is not received from the AP within a defined time. The instructions, when executed by the at least one processor, may cause the electronic device to, in a case where a response message corresponding to the DHCP request message is not received from the AP within a defined time, release the Wi-Fi connection between the electronic device and the AP, and refrain from establishing the Wi-Fi connection between the AP and the electronic device, based on the quality of a signal received from the AP being less than a second threshold value that is greater than the first threshold value.

An operation method of an electronic device according to an example may include an operation of establishing a Wi-Fi connection, via short-range wireless communication, with an access point (AP) based on the quality of a signal received from the AP being greater than or equal to a first threshold value representing a minimum value of quality required for connection via the short-range wireless communication. The operation method of the electronic device may include an operation of transmitting an address resolution protocol (ARP) request message to the AP, after connecting to the AP. The operation method of the electronic device may include an operation of transmitting, to the AP, a dynamic host configuration protocol (DHCP) request message for acquiring an Internet Protocol (IP) address of the electronic device when a response message corresponding to the ARP request message is not received from the AP within a defined time. The operation method of the electronic device may include an operation of releasing the Wi-Fi connection between the electronic device and the AP when a response message corresponding to the DHCP request message is not received from the AP within a defined time, and refraining from establishing the connection between the AP and the electronic device, based on the quality of a signal received from the AP being less than a second threshold value greater than the first threshold value.

An electronic device and a method of operating the electronic device according to an embodiment may identify that, after a connection between the electronic device and an AP is completed, a beacon signal is not received from the AP within a defined time. When a beacon signal is not received from the AP within the defined time, the electronic device may release the connection between the electronic device and the AP and/or increase a threshold value representing a minimum value of quality required for connection via short-range wireless communication. The electronic device may resolve instability of data transmission and/or reception due to the connection with the AP that is incapable of providing appropriate performance, by releasing the connection between the electronic device and the AP. By increasing the threshold value, the electronic device may reduce the number of attempts to connect to an AP that is incapable of providing appropriate performance, and/or may hinder the connection, thereby reducing or preventing a phenomenon in which the connection between the electronic device and the AP is repeatedly released and reconnected.

An electronic device and a method of operating the electronic device according to an embodiment may transmit a DHCP request message to an AP when a response message corresponding to an ARP request message is not received after a connection between the electronic device and an AP is completed. When a response message corresponding to the DHCP request message is not received, the electronic device may release the connection between the electronic device and the AP, and/or increase a threshold value representing a minimum value of quality required for connection via short-range wireless communication. The electronic device may eliminate instability of data transmission and/or reception due to the connection with the AP that is incapable of providing appropriate performance by releasing the connection between the electronic device and the AP. By increasing the threshold value, the electronic device may reduce the number of attempts to connect to an AP that is incapable of providing appropriate performance and/or may prevent the connection, thereby reducing or preventing a phenomenon in which the connection between the electronic device and the AP is repeatedly released and reconnected.

The effects obtainable in the disclosure are not limited to the above-mentioned effects, and other effects which are not mentioned may be clearly understood from the following description by those skilled in the art to which the disclosure pertains.

### BRIEF DESCRIPTION OF THE DRAWINGS

FIG. 1 is a block diagram of an electronic device according to an embodiment.

FIG. 2 illustrates an example of a wireless LAN system according to an embodiment.

FIG. 3 is a diagram illustrating an example of a link setup operation according to an embodiment.

FIG. 4 is a diagram illustrating an example in which an electronic device repeatedly releases and re-establishes a connection to an AP according to an embodiment.

FIG. 5 is a block diagram of an electronic device according to an embodiment.

FIG. 6 is a diagram illustrating an example in which an electronic device increases a threshold value representing a minimum value of quality required for connection via short-range wireless communication, according to an embodiment.

FIG. 7 is a flowchart illustrating a method of operating an electronic device according to an embodiment.

FIG. 8 is a flowchart illustrating a method of operating an electronic device according to an embodiment.

FIG. 9 is a flowchart illustrating a method of operating an electronic device according to an embodiment.

### DETAILED DESCRIPTION

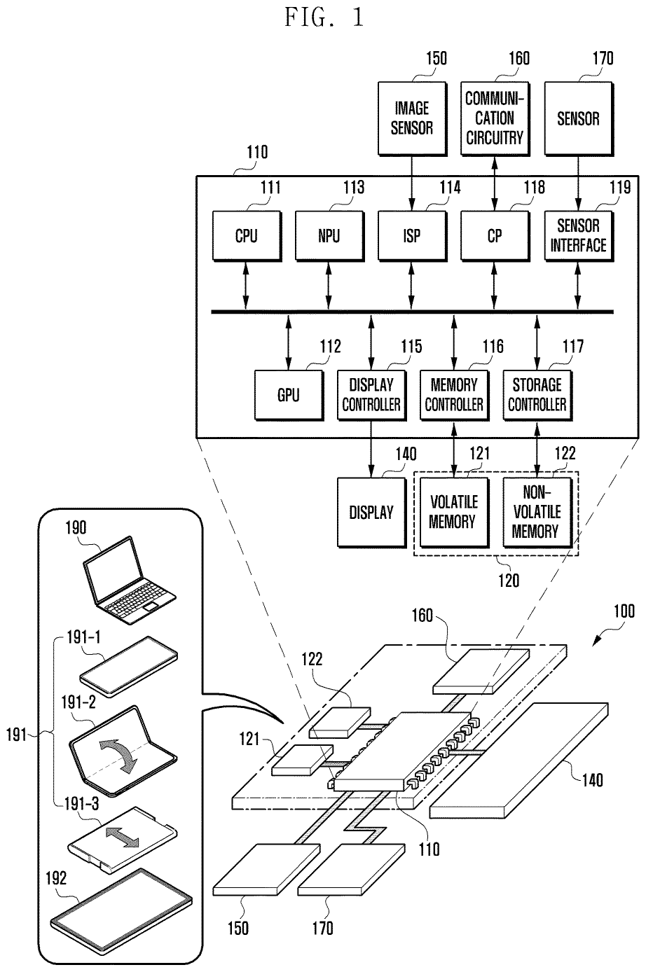

FIG. 1 illustrates a block diagram of an exemplary electronic device 100 capable of performing the operations described herein.

Referring to FIG. 1, the electronic device 100 may be one of various types of electronic devices, such as a notebook computer 190, smartphones 191 having various form factors (e.g., a bar-type smartphone 191-1, a foldable smartphone 191-2, or a slidable (or rollable) smartphone 191-3), a tablet PC 192, a cellular telephone (not shown), and any other similar computing devices (not shown). The components illustrated in FIG. 1, the relationships thereof, and the functions thereof are merely for illustration, and are not intended to limit the implementations described or claimed in the disclosure thereto. The electronic device 100 may be referred to as a mobile device, a user equipment, a multifunctional device, a portable device, or a server.

The electronic device 100 may comprise various components including at least one processor 110 (hereinafter, the processor 110), at least one memory 120 (hereinafter, the memory 120), at least one display 140 (hereinafter, the display 140), at least one image sensor 150 (hereinafter, the image sensor 150), at least one communication circuitry 160 (hereinafter, the communication circuitry 160), and/or at least one sensor 170 (hereinafter, the sensor 170). The aforementioned components are merely of an example. For example, the electronic device 100 may comprise other components (e.g., a power management integrated circuitry (PMIC), an audio processing circuitry, an antenna, a rechargeable battery, or an input/output interface). For example, some components may be omitted from the electronic device (100). For example, some components may be integrated into one component.

The processor 110 may be implemented as one or more integrated circuit (or circuitry) (IC) chips and may perform various data processing. The processor 110 may include at least one electrical circuitry and may process instructions (or program, data, and so on) stored in the memory 120 individually or collectively in a distributed manner. The processor 110 may include a processor assembly that includes one or more processing circuitries. The processor may include any processing circuitry that may be operative for controlling operations and performance of one or more components (e.g., the memory 120, a display 140, the image sensor 150, the communication circuitry 160, and/or the sensor 170) of the electronic device. For example, the processor 110 (e.g., an application processor (AP)) may be implemented as a system on chip (SoC) (e.g., one chip or chipset). For example, the processor 110 may be implemented as a plurality of cores (or at least one core circuitry), a plurality of chips, or a plurality of chipsets. For example, the processor 110 may comprise one or more processing circuitry. For example, the processor 110 may comprise one or more processing circuitry which are individually and/or collectively configured to perform various functions of the present disclosure. As a non-limiting example, at least a portion of the processor 110 may be included in a first chip of the electronic device 100 and at least another portion of the processor 110 may be included in a second chip of the electronic device 100 different from the first chip of the electronic device 100.

For example, the processor 110 may comprise a central processing unit (CPU) 111, a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. These components of the processor 110 are merely of an example. For example, the processor 110 may further comprise other components. For example, some components of the processor 110 may be omitted from the processor 110. For example, some components of the processor 110 may be included as separate components of the electronic device 100 outside the processor 110. For example, some components of the processor 110 (e.g., the memory controller 116) may be included in other components of the electronic device 100 (e.g., at least a portion of the memory 120, an interface (e.g., usable for connecting to at least one component of the electronic device 100), the display 140, and/or the image sensor 150).

The processor 110 may cause other components of the electronic device 100 to perform various operations by executing instructions stored in the memory 120. The CPU 111 (or a central processing circuitry) may be configured to control the components of the processor 110 based on execution of instructions stored in the memory 120 (e.g., the volatile memory 121 and/or the non-volatile memory 122). The GPU 112 (or a graphic processing circuitry) may be configured to execute parallel computations (e.g., rendering). The NPU 113 (or a neural processing circuitry, or an artificial intelligence (AI) chip) may be configured to execute operations (e.g., convolution computations) for an artificial intelligence model. The ISP 114 (or an image signal processing circuitry) may be configured to process a raw image obtained from the image sensor 150 in a format suitable for a component in the electronic device 100 or a component of the processor 110. The display controller 115 (or a display control circuitry, or a display processing unit (DPU)) may be configured to process an image obtained from the CPU 111, the GPU 112, the ISP 114, or the memory 120 (e.g., the volatile memory 121) in a format suitable for the display 140. The memory controller 116 (or a memory control circuitry) may be configured to control reading data from the volatile memory 121 and writing data to the volatile memory 121. The storage controller 117 (or a storage control circuitry) may be configured to control reading data from the non-volatile memory 122 and writing data to the non-volatile memory 122. The CP 118 (or a communication processing circuitry) may be configured to process data obtained from a component of the processor 110 in a format suitable for transmission to another electronic device via the communication circuitry 160, or to process data obtained from another electronic device via the communication circuitry 160 in a format suitable for processing of the component of the processor 110. For example, the communication circuitry 160 may comprise one or more communication circuitry. The sensor interface 119 (or a sensing data processing circuitry, a sensor hub) may be configured to process data on a state of the electronic device 100 and/or a state around the electronic device 100, obtained through the sensor 170, in a format suitable for a component of the processor 110.

The memory 120 may comprise one or more storage mediums (or one or more storage devices). For example, the memory 120 may include a memory assembly that includes one or more storage mediums. For example, the one or more storage mediums may comprise a permanent memory (e.g., the non-volatile memory 122) such as a hard drive, a flash memory, a read-only memory (ROM), a semi-permanent memory (e.g., the volatile memory 121) such as a random access memory (RAM), a storage (or a storage assembly) of any other suitable type, or any combination thereof. The memory 120 may comprise a cache memory which is a memory of one or more different types used to store data for performing a function or feature of the electronic device 100 at least temporarily. As a non-limiting example, the cache memory may be included in the processor 110. The memory 120 may be fixedly embedded within the electronic device 100, or may be incorporated onto one or more suitable types of components that may be repeatedly inserted into the electronic device 100, and removed from the electronic device 100 (e.g., a subscriber identity module (SIM) card, and/or a secure digital (SD) card).

For example, the memory 120 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 110. For example, the memory 120 may store instructions callable by an application programming interface (API). For example, the memory 120 may store instructions in a library.

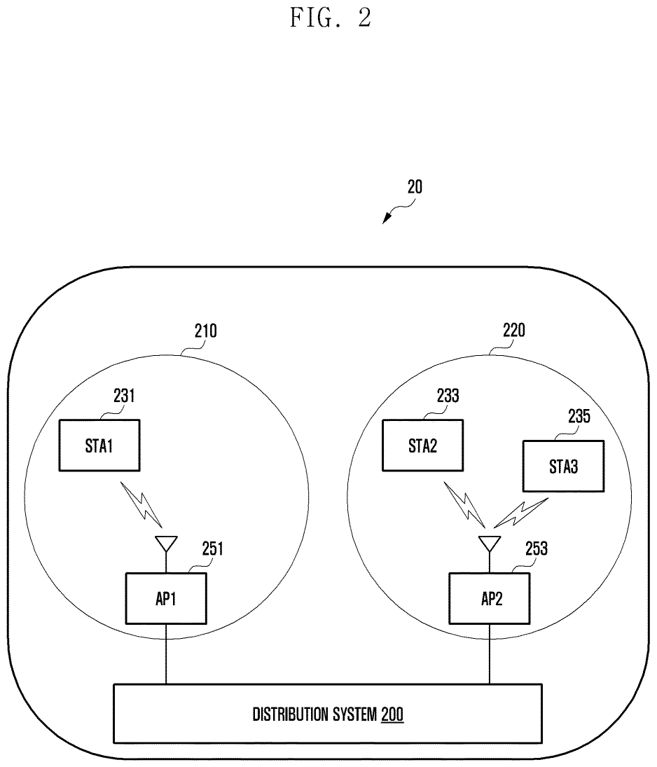

FIG. 2 is a diagram illustrating an example of a wireless local area network (LAN) system according to an embodiment.

Referring to FIG. 2, according to an embodiment, a wireless LAN system 20 may refer to an infrastructure mode in which at least one access point (AP) and a station (STA) communicating via the AP exist in a wireless local area network (WLAN) structure according to the institute of electrical and electronic engineers (IEEE) 802.11 standard. The wireless LAN system 20 may include one or more basic service sets (BSSs) (e.g., BSS1 210 and/or BSS2 220). A BSS (e.g., BSS1 210 and/or BSS2 220) may refer to a set of an AP and one or more STAs (e.g., the electronic device 100 in FIG. 1) that successfully achieve synchronization and are capable of communicating with each other. For example, the BSS1 210 may include an AP1 251 and an STA1 231, and the BSS2 220 may include two or more STAs (e.g., STA2 233 and STA3 235) capable of associating with one AP2 253.

According to an embodiment, the wireless LAN system 20 may include at least one STA (e.g., STA1 231, STA2 233, and/or STA3 235), at least one AP (e.g., AP1 251 and/or AP2 253) that provides access to a distribution system service, and/or a distribution system 200 that connects a plurality of APs (e.g., AP1 251 and AP2 253). The distribution system 200 may refer to a network connected by an AP (e.g., AP1 251 and AP2 253), and generally refers to a wired infrastructure. The distribution system 200 may implement an extended service set (ESS) by connecting at least one BSS (e.g., BSS1 210 and/or BSS2 220). An ESS may be used as a term indicating one network configured with one or more APs (e.g., AP1 251 and/or AP2 253) connected via the distribution system 200. The plurality of APs (e.g., AP1 251 and AP2 253) included in one ESS may have the same service set identification (SSID).

According to an embodiment, a STA (e.g., STA1 231, STA2 233, and/or STA3 235) may be a logical entity including a medium access control (MAC) and a physical layer interface for a wireless medium that comply with the regulations of the IEEE 802.11 standard. An STA may be used to refer to both an AP-STA and a non-AP station (non-AP STA). According to an embodiment, an STA may refer to a non-AP STA, and an AP may refer to an AP-STA. The STA (e.g., STA1 231, STA2 233, and/or STA3 235) may also be referred to as various other names, such as an electronic device, a mobile terminal, a wireless device, a wireless transmit/receive unit (WTRU), a user equipment (UE), a mobile station (MS), a mobile subscriber unit, or simply a user, and may be included in such devices.

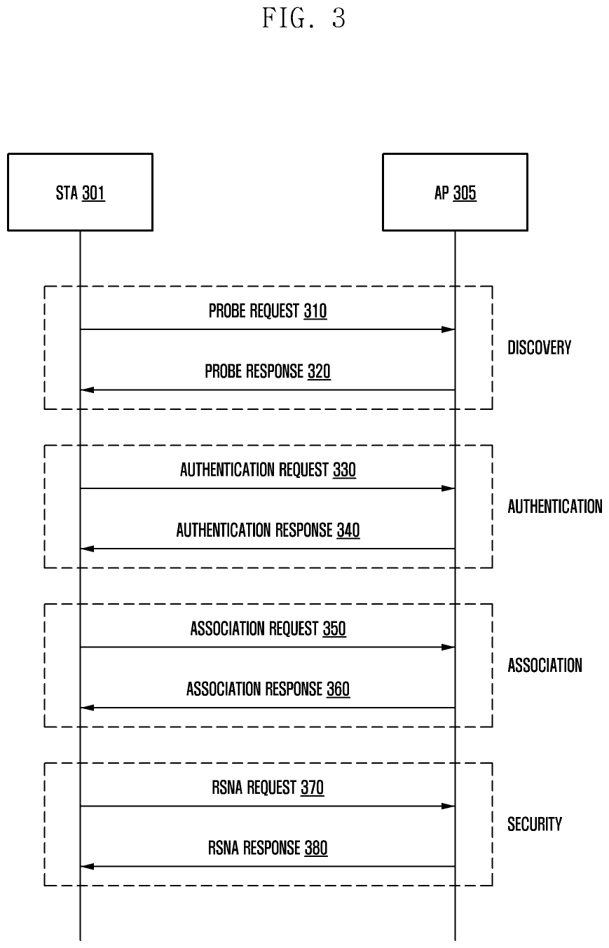

FIG. 3 is a diagram illustrating an example of a link setup operation according to an embodiment.

Referring to FIG. 3, according to an embodiment, a link setup operation may be performed between devices (e.g., STA 301 and AP 305) in order to perform communication with each other. In order to perform a link setup, operations of discovering a network, performing authentication, establishing an association (or connection), and performing a setup operation for security may be performed. The link setup operation may be referred to as a session initiation operation or a session setup operation. In addition, the discovery, authentication, association, and security setup operations of the link setup operation may be collectively referred to as an association operation.

According to an embodiment, the network discovery operation may include operations 310 and 320. In operation 310, an STA 301 (e.g., the electronic device 100 in FIG. 1) may transmit a probe request frame to discover an AP, and wait for a response to the probe request frame. The STA 301 may perform a scanning operation to discover a network to which to participate in order to access a network. For example, the probe request frame may include information of the STA 301 (e.g., the device name and/or address of the STA 301). The scanning operation in operation 310 may refer to an active scanning operation. In operation 320, the AP 305 may transmit a probe response frame to the STA 301 as a response to the probe request frame. For example, the probe response frame may include information associated with the AP 305 (e.g., a device name and/or network information of the AP 305). Although the network discovery operation is illustrated as being performed via active scanning in FIG. 3, this is not necessarily limited thereto. For example, the network discovery operation may be performed via passive scanning. In a case where the STA 301 performs passive scanning, the operation of transmitting the probe request frame may be omitted. The STA 301 that performs passive scanning may receive a beacon frame transmitted by the AP 305 and perform the following subsequent procedures. A beacon frame may be a frame periodically broadcast to notify of the presence of a BSS managed by the AP 305. For example, the beacon frame may include information associated with at least one of a timestamp for synchronizing at least one STA including the STA 301, a beacon interval and period, capability information, and an SSID.

According to an embodiment, after the STA 301 discovers a network, the authentication operation including operation 330 and operation 340 may be performed. In operation 330, the STA 301 may transmit an authentication request frame to the AP 305. In operation 340, the AP 305 may determine whether to allow authentication for the corresponding STA 301, based on information included in the authentication request frame. The AP 305 may provide a result of the authentication process to the STA 301 through an authentication response frame. An authentication frame (e.g., authentication request frame and/or authentication response frame) used for an authentication request/response may correspond to a management frame.

According to an embodiment, the authentication frame may include information associated with an authentication algorithm number, an authentication transaction sequence number, a status code, a challenge text, a robust security network (RSN), and/or a finite cyclic group.

According to an embodiment, after the STA 301 is successfully authenticated, the association operation including operations 350 and 360 may be performed. In operation 350, the STA 301 may transmit an association request frame to the AP 305. In operation 360, the AP 305 may transmit an association response frame to the STA 301 in response to the association request frame.

According to an embodiment, the association request frame and/or the association response frame may include information associated with various capabilities. For example, the association request frame may include information associated with various capabilities, a beacon listen interval, a service set identifier (SSID), supported rates, supported channels, RSN, a mobility domain, supported operating classes, a traffic indication map (TIM) broadcast request, and/or information associated with an interworking service capability. For example, the association response frame may include information associated with various capabilities, a status code, an association ID (AID), supported rates, an enhanced distributed channel access (EDCA) parameter set, a received channel power indicator (RCPI), a received signal to noise indicator (RSNI), a mobility domain, a timeout interval (association comeback time), an overlapping BSS scan parameter, a TIM broadcast response, and/or information such as a quality of service (QoS) map.

According to an embodiment, after the STA 301 successfully associates with the network, the security setup operation including operations 370 and 380 may be performed. The security setup operation may be performed through a robust security network association (RSNA) request/response. For example, the security setup operation may include an operation of performing a private key setup via 4-way handshaking using an extensible authentication protocol over LAN (EAPOL) frame. The security setup operation may be performed according to a security scheme not defined in the IEEE 802.11 standard.

According to an embodiment, a security session may be configured between the STA 301 and the AP 305 according to the security setup operation, and the STA 301 and the AP 305 may perform secure data communication.

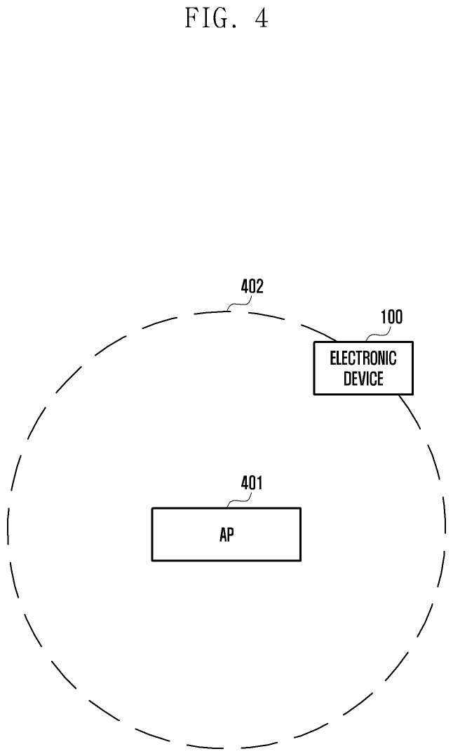

FIG. 4 is a diagram illustrating an example in which an electronic device repeatedly releases and re-establishes a connection to an AP according to an embodiment.

An electronic device (e.g., the electronic device 100 in FIG. 1) may perform the link setup operation described in FIG. 3 and may be connected to an access point (AP) 401 (e.g., the AP 305 in FIG. 3) via short-range wireless communication. The electronic device 100 may transmit and/or receive data to/from an entity outside the AP 401 via the short-range wireless communication provided by the AP 401. According to an example, the electronic device 100 may perform a role of an STA defined in IEEE 802.11.

In order to connect to the AP 401, the electronic device 100 may perform a procedure for discovering (or scanning) the AP 401 connectable to the electronic device 100. The electronic device 100 may receive a signal from the AP 401, and may identify whether the signal satisfies a predetermined condition. The electronic device 100 may be connected to the AP 401 via short-range wireless communication when the quality of the signal satisfies the predetermined condition. The quality of the signal may be expressed, for example, as a received signal received power (RSRP) or a received signal strength indicator (RSSI) of the signal. According to an example, the predetermined condition may include a condition that a quality of a signal is greater than or equal to (or exceeds) a threshold value. The threshold value may refer to a value representing a minimum quality of the AP 401 connectable to the electronic device 100. According to an example, the threshold value may be referred to as various names representing a minimum signal quality. For example, the threshold value may be defined as an entry RSSI. The electronic device 100 may be connected to the AP 401 via short-range wireless communication, based on the quality of the signal received from the AP 401 being greater than or equal to (or exceeds) the threshold value.

According to an example, when the electronic device 100 is connected to the AP 401 via the short-range wireless communication, the electronic device 100 may transmit data to an external device via the short-range wireless communication and may receive data transmitted by the external device via the short-range wireless communication.

According to an example, in the case of transmitting data, the electronic device 100 may perform a procedure of acquiring an address (e.g., MAC address) of an external device that is to receive data. The electronic device 101 may transmit, through the AP 401 or to a gateway connected to the AP 401, a message (e.g., an ARP request message) including an IP address of the external device. When the AP 401 also performs the role of a gateway, the electronic device 101 may transmit an ARP request message to the AP 401. The AP 401 or the gateway may receive the ARP request message and identify the IP address of the external device included in the ARP request message. The AP 401 or the gateway may acquire a MAC address corresponding to the external device's IP address, and transmit an ARP response electronic device 100 may transmit data to the external device via short-range wireless communication by using the MAC address of the external device included in the ARP response message.

However, the electronic device 100, as a mobile device, may have a changed position. Referring to FIG. 4, the electronic device 100 may move to a position 402 where the quality of a signal received from the AP 401 may be measured to be the threshold value or a value substantially equal to the threshold value.

When the electronic device 100 is located outside the position 402 where the quality of a signal received from the AP 401 is measured to be the threshold value or a value substantially equal to the threshold value, it may be difficult to perform short-range wireless communication provided by the AP 401. The electronic device 100 may release the short-range wireless communication between the electronic device 100 and the AP 401, and transmit and/or receive data via cellular wireless communication. When the electronic device 100 is located in the position 402 where the quality of a signal received from the AP 401 is measured to be the threshold value or a value substantially equal to the threshold value, the connection between the electronic device 100 and the AP 401 may be repeatedly released and reconnected due to an error in measuring the quality of a signal.

If the connection between the electronic device 100 and the AP 401 is repeatedly released and reconnected, the electronic device 100 may have difficulty in data transmission and/or reception, and may have difficulty in performing a service that may be provided via the short-range wireless communication. The electronic device 100 may perform data transmission and/or reception via cellular wireless communication by prohibiting the connection to the AP 401 via short-range wireless communication, but data transmission and/or reception via cellular wireless communication may cause additional charges to a user of the electronic device 100 and may cause more inconvenience to the user of the electronic device 100. Furthermore, although the electronic device 100 moves in a direction that decreases a distance between the electronic device 100 and the AP 401, it may cause inconvenience in that the electronic device 100 is incapable of performing the short-range wireless communication.

Hereinafter, an example in which the electronic device 100 changes a threshold value so as to reduce the repetition of establishing and releasing the connection between the electronic device 100 and the AP 401 will be described.

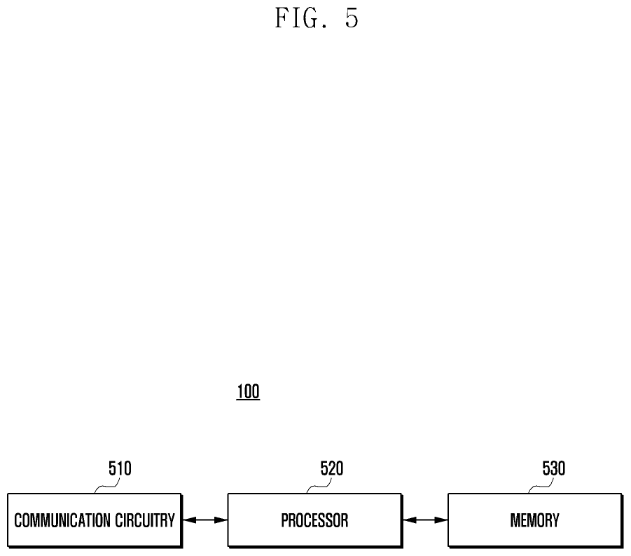

FIG. 5 is a block diagram of an electronic device according to an embodiment.

According to an embodiment, an electronic device (e.g., the electronic device 100 in FIG. 1) may include communication circuitry 510 (e.g., the communication circuitry 160 in FIG. 1), a processor 520 (e.g., the processor 110 in FIG. 1), and/or a memory 530 (e.g., the memory 120 in FIG. 1).

The communication circuitry 510 may be a communication circuitry that supports short-range wireless communication. The short-range wireless communication may include various short-range wireless communications supportable by the electronic device 100. For example, the short-range wireless communication may be Wi-Fi.

The communication circuitry 510 may include various circuit structures used for signal modulation and/or demodulation in the electronic device 100. For example, the communication circuitry 510 may modulate a baseband signal into a radio frequency (RF) band signal and output the same through an antenna (not shown), or demodulate an RF band signal received through the antenna into a baseband signal and transmit the same to the processor 520.

The processor 520 may be electrically or operatively connected to the communication circuitry 510, and control the communication circuitry 510. The processor 520 may include at least one processor, and the at least one processor may individually or collectively perform the following operations. The processor 520 may be the processor 110 illustrated in FIG. 1. Alternatively, the processor 520 may be a processor implemented inside the communication circuitry 510, and when the processor 520 is implemented inside the communication circuitry 510, the processor 520 may be referred to as a core.

The memory 530 may store instructions which may be executed by the processor 520. The operations of the processor 520 described below may be performed in accordance with the execution of instructions stored in the memory 530.

The processor 520 may control the communication circuitry 510 to discover an AP (e.g., the AP 401 in FIG. 4) that may provide short-range wireless communication, in order to perform short-range wireless communication. In order to discover the AP 401, the processor 520 may control the communication circuitry 510 to broadcast a probe request message. The probe request message may include information associated with the electronic device 100. According to an example, the probe request message may include various identification information (e.g., a MAC address) for distinguishing the electronic device 100 from other electronic devices, and performance information associated with the short-range wireless communication of the electronic device 100. When receiving a probe request message, the AP 401 may transmit a probe response message corresponding to the probe request message to the electronic device 100. The processor 520 may successfully discover the AP 401 when receiving the probe response message.

According to another example, the processor 520 may successfully discover the AP 401 by receiving a beacon signal broadcast by the AP 401.

The processor 520 may identify a quality of the signal (e.g., the beacon signal broadcast by the AP 401 or the probe response message transmitted by the AP 401) received from the AP 401. The processor 520 may identify whether the quality of the signal satisfies a predetermined condition. When the quality of the signal satisfies the predetermined condition, the processor 520 may be connected to the AP 401 via short-range wireless communication.

The quality of the signal may be expressed as, for example, a received signal received power (RSRP) or a received signal strength indicator (RSSI) of the signal. According to an example, the predetermined condition may include a condition that the quality of a signal is greater than or equal to a threshold value. The threshold value may refer to a value representing a minimum quality of the AP 401 connectable to the electronic device 100. According to an example, the threshold value may be referred to as various names representing a minimum signal quality. For example, the threshold value may be defined as an entry RSSI. The processor 520 may be connected to the AP 401 via the short-range wireless communication, based on the quality of the signal received from the AP 401 being greater than or equal to a first threshold value.

The operation of the processor 520 or the electronic device 100 described below is described based on the assumption that a signal quality is a signal strength, but the signal quality may be expressed as other parameters in addition to the signal strength. The quality of the signal may be expressed as, for example, an error rate (e.g., a packet error rate (PER), a bit error rate (BER), or a frame error rate (FER)) of a signal. According to an example, the predetermined condition may include a condition that an error rate of a signal is less than or equal to than a threshold value. The threshold value may refer to a value representing a minimum error rate of the AP 401 connectable to the electronic device 100. The processor 520 may be connected to the AP 401 via short-range wireless communication when the error rate of the signal received from the AP 401 is less than or equal to the threshold value.

The processor 520 may establish a connection to the discovered AP 401 via short-range wireless communication, based on the quality of the signal received from the AP 401 being greater than or equal to the first threshold value. As described with reference to FIG. 3, the processor 520 may perform an authentication procedure with the discovered AP 401, an association procedure with the AP 401, and/or a security setup procedure with the AP 401. The processor 520 may complete the above procedures and complete the establishment of the connection with the AP 401. Connection between the electronic device 100 and the AP 401 via short-range wireless communication may be referred to as a Wi-Fi connection.

The processor 520 may perform a dynamic host configuration protocol (DHCP) procedure for acquiring an IP address required for the electronic device 100 to perform short-range wireless communication, as part of the procedure of connecting to the AP 401. The processor 520 may perform the DHCP procedure so that the electronic device 100 may be assigned an IP address. In the DHCP procedure, the electronic device 100 may transmit a DHCP discovery message to the AP 401 in order to discover a DHCP server capable of allocating an IP address of the electronic device 100. The AP 401 may transfer the DHCP discovery message transmitted by the electronic device 100 to the DHCP server, and, upon receiving the DHCP discovery message, the DHCP server may transmit a DHCP offer message including an IP address available to the electronic device 100 and configuration parameters to the electronic device 100 through the AP 401. The electronic device 100 may transmit, to the AP 401, a DHCP request message including the IP address to be used by the electronic device 100, based on the DHCP offer message. In response to receiving of the DHCP request message, the DHCP server may transmit a response message to the electronic device 100. Although it is described that the AP 401 and the DHCP server are implemented separately in the above description, the AP 401 may also perform the role of the DHCP server, concurrently.

The processor 520 may receive the IP address of the electronic device 100 via the above-described method and may perform short-range wireless communication using the IP address.

According to an example, when the electronic device 100 is connected to the AP 401 via short-range wireless communication, the electronic device 100 may transmit data to an external device via the short-range wireless communication, and may receive data transmitted from the external device via the short-range wireless communication.

According to an example, in the case of transmitting data, the processor 520 may perform a procedure of acquiring an address (e.g., a MAC address) of the external device that is to receive the data. The processor 520 may transmit, through the AP 401 or to a gateway connected to the AP 401, a message (e.g., an ARP request message) including the IP address of the external device. Alternatively, when the AP 401 is also capable of performing the role of a gateway, the processor 520 may transmit an ARP request message to the AP 401. The processor 520 may, after completing the establishment of a Wi-Fi connection to the AP 401, transmit the ARP request message to the AP 401. The AP 401 or the gateway may receive the ARP request message and identify the IP address of the external device included in the ARP request message. The AP 401 or the gateway may acquire a medium access control (MAC) address corresponding to the external device's IP address, and may transmit an ARP response processor 520 may transmit data to the external device via the short-range wireless communication by using the MAC address of the external device included in the ARP response message.

The processor 520 may control the communication circuitry 510 to transmit the ARP request message to the AP 401. However, the processor 520 may be unable to receive the ARP response message corresponding to the ARP request message.

According to an example, as the electronic device 100 moves to the position 402 where the quality of a signal received from the AP 401 is measured to be a threshold value or a value substantially equal to the threshold value, the quality of the short-range wireless communication may be degraded. The AP 401 may be unable to receive the ARP request message, and therefore, may be unable to transmit the ARP response message to the electronic device 100. Alternatively, although the AP 401 receives the ARP request message and transmits the ARP response message, the electronic device 100 may be unable to receive the same. When the ARP response message is not received, the electronic device 100 may be unable to acquire the MAC address of the external device with which data transmission and/or reception is to be performed, and thus may be unable to perform short-range wireless communication. However, the electronic device 100 may be in a state where the connection with the AP 401 is not released.

When the ARP response message is not received, which is a response message corresponding to the ARP request message, the processor 520 may determine whether to release the connection between the electronic device 100 and the AP 401 and whether to perform an operation of increasing (or changing) a threshold value as follows.

The processor 520 may perform a procedure for reacquiring (or updating) the IP address of the electronic device 100 when the ARP response message is not received. In order to reacquire (or update) the IP address of the electronic device 100, the processor 520 may transmit a DHCP request message to the AP 401 or the gateway connected to the AP 401.

Upon receiving the DHCP request message, the AP 401 may attempt to transmit a DHCP response message corresponding to the DHCP request message to the electronic device 100. The DHCP response message may include an IP address available to the electronic device 100. When the processor 520 receives the DHCP response message within a defined time, the processor 520 may maintain the connection between the electronic device 100 and the AP 401 and maintain the threshold value. Receiving the DHCP response message within the defined time may indicate that the quality of a channel between the electronic device 100 and the AP 401 is at a level that enables short-range wireless communication. That is, the non-reception of the ARP response message may be a temporary error.

The processor 520 may disconnect the connection between the electronic device 100 and the AP 401 and increase the threshold value when the DHCP response message is not received within the defined time.

The situation in which the DHCP response message is not received within the defined time may indicate that the quality of the channel between the electronic device 100 and the AP 401 is in a state insufficient for performing short-range wireless communication. Therefore, the processor 520 may release the connection between the electronic device 100 and the AP 401, and may transmit and/or receive data via another wireless communication (e.g., cellular wireless communication or short-range wireless communication provided by another AP) instead of the short-range wireless communication provided by the AP 401, thereby reducing a degradation in the quality of a service using the transmitted and/or received data.

The processor 520 may change the threshold value in response to identifying that the DHCP response message is not received within the defined time. According to an example, when the processor 520 does not receive the DHCP response message within the defined time, the processor 520 may increase the threshold value.

An increase in the threshold value may indicate an operation of reducing a possibility that the electronic device 100 and the AP 401 may be connected via short-range wireless communication. The greater the threshold value, the higher the quality of a signal received from the AP 401 for the electronic device 100 and the AP 401 to be connected via short-range wireless communication.

For example, when the quality of a signal received from the AP 401 has the first threshold value which is higher than the threshold value, the processor 520 may connect to the AP 401 via short-range wireless communication. When the processor 520 changes (or increases) the threshold value to a second threshold value higher than the first threshold value, the processor 520 may not connect to the AP 401.

The processor 520 may refrain from establishing the connection between the electronic device 100 and the AP 401 by increasing the threshold value from the first threshold value to the second threshold value, and may prevent (or reduce) the user's inconvenience of attempting to connect to and connecting to the AP 401 even in a state insufficient for the electronic device 100 to perform short-range wireless communication.

According to an example, the processor 520 may increase the threshold value, identify the quality of a signal received from the AP 401, and identify that the quality of the signal is lower than the increased threshold value (e.g., second threshold value), and may refrain from establishing, or prevent, the connection between the AP 401 and the electronic device 100, based on the identification.

Through the above-described method, the electronic device 100 may reduce (or prevent) a phenomenon in which the connection between the electronic device 100 and the AP 401 is repeatedly released and reconnected by increasing the threshold value.

The processor 520 may determine whether to increase the threshold value based on whether a response message corresponding to the DHCP request message is received, but may also determine whether to increase the threshold value in consideration of various variables.

According to an example, the processor 520 may receive a beacon signal from the AP 401 at a predetermined cycle. However, as a distance between the electronic device 100 and the AP 401 increases, the processor 520 may be unable to receive a beacon signal from the AP 401.

Based on a case in which a beacon signal is not received from the AP 401 within a defined time, the processor 520 may release the connection between the electronic device 100 and the AP 401 via short-range wireless communication and increase the threshold value from the first threshold value to the second threshold value. The defined time may be a multiple of a transmission cycle of a beacon transmitted by the AP 401, but is not limited thereto. The defined time may be changed according to the characteristics of a service performed by the electronic device 100. For example, when the electronic device 100 performs a service requiring a low delay time, the defined time may be reduced. Alternatively, when the electronic device 100 performs a background service, the defined time may be configured to be long.

The situation in which a beacon signal is not received from the AP 401 within the defined time may indicate that the quality of the channel between the electronic device 100 and the AP 401 is in a state insufficient for performing short-range wireless communication. Therefore, the processor 520 may release the connection between the electronic device 100 and the AP 401, and transmit and/or receive data via another wireless communication (e.g., cellular wireless communication or short-range wireless communication provided by another AP) instead of the short-range wireless communication provided by the AP 401, thereby reducing a decrease in the quality of a service using the transmitted and/or received data.

According to another example, the processor 520 may increase the threshold value from the first threshold value to the second threshold value, based on the number of releases and re-establishments of the connection between the electronic device 100 and the AP 401 being greater than or equal to a predetermined number.

The situation in which the number of releases and re-establishments of the connection between the electronic device 100 and the AP 401 is greater than or equal to the predetermined number may indicate that the quality of the channel between the electronic device 100 and the AP 401 is in a state insufficient for performing short-range wireless communication. Therefore, the processor 520 may release the connection between the electronic device 100 and the AP 401, and transmit and/or receive data via another wireless communication (e.g., cellular wireless communication or short-range wireless communication provided by another AP) instead of the short-range wireless communication provided by the AP 401, thereby reducing the degradation of the quality of a service using the transmitted and/or received data.

According to another example, the processor 520 may transmit, to the AP 401, a domain name service (DNS) query for requesting an IP address corresponding to a domain name of a website to be connected. The processor 520 may increase the threshold value from the first threshold value to the second threshold value, based on a failure to receive, within a defined time, a response message (including an IP address) corresponding to the DNS query from the AP 401.

The situation in which the electronic device 100 does not receive a response message corresponding to the DNS query may indicate that the quality of the channel between the electronic device 100 and the AP 401 is in a state insufficient for performing short-range wireless communication. Therefore, the processor 520 may release the connection between the electronic device 100 and the AP 401, and transmit and/or receive data via another wireless communication (e.g., cellular wireless communication or short-range wireless communication provided by another AP) instead of the short-range wireless communication provided by the AP 401, thereby reducing the degradation of the quality of a service using the transmitted and/or received data.

According to another example, the processor 520 may transmit data via the Wi-Fi connection established between the AP 401 and the electronic device 100. In order to transmit data, the processor 520 may attempt to create a transmission control protocol (TCP) socket. However, the processor 520 may fail to generate the TCP socket due to various causes. For example, the processor 520 may transmit a synchronize signal to an external server (or gateway) through the AP 401 for the generation of a TCP socket. When a response message (SYN-ACK) corresponding to the synchronization signal is received, the processor 520 may complete the generation of the TCP socket by transmitting an ACK signal to the external server (or gateway). However, when a response message (SYN-ACK) corresponding to the synchronization signal is not received, the processor 520 may fail to generate the TCP socket, and thus may not transmit and/or receive data through the AP 401. The processor 520 may increase the threshold value from the first threshold value to the second threshold value, based on a response message (SYN-ACK) corresponding to the synchronization signal from the AP 401 not being received within a defined time.

The situation in which the electronic device 100 does not receive the response message (SYN-ACK) corresponding to the synchronization signal from the AP 401 within the defined time may indicate that the quality of the channel between the electronic device 100 and the AP 401 is in a state insufficient for performing short-range wireless communication. Therefore, the processor 520 may release the connection between the electronic device 100 and the AP 401, and transmit and/or receive data via another wireless communication (e.g., cellular wireless communication or short-range wireless communication provided by another AP) instead of the short-range wireless communication provided by the AP 401, thereby reducing the degradation of the quality of a service using the transmitted and/or received data.

According to another example, the processor 520 may identify the number of sockets having an increased number of retransmitted packets among packets transmitted through the respective sockets, among the TCP sockets established by the electronic device 100. The processor 520 may identify the states of the TCP packets established by the electronic device 100, and the states of the TCP sockets may be stored in a file existing in a predetermined path (e.g., /proc/net/tcp). The file may include the states of TCP sockets, and for example, may include the number of retransmissions of packets through the TCP sockets. The processor 520 may increase the threshold value from the first threshold value to the second threshold value, based on the number of sockets having an increased number of retransmitted packets among the packets transmitted through the respective sockets, among the TCP sockets established by the electronic device 100, satisfying a predetermined condition. The predetermined condition may include a condition that the number of sockets having an increased number of retransmitted packets increases and/or a condition that the number of sockets having an increased number of retransmitted packets is greater than or equal to a predetermined number.

In increasing the threshold value, the processor 520 may increase the threshold value in consideration of the quality of a signal received from the AP 401. For example, the processor 520 may increase the threshold value, based on at least one of the quality of a signal measured at or before the time when a situation of performing data transmission and/or reception via short-range wireless communication is switched to a situation of performing data transmission and/or reception via cellular wireless communication, the quality of a signal measure at or before the time when it is determined that a response message corresponding to an ARP request message is not received, the quality of a signal measured at or before the time when the connection between the electronic device 100 and the AP 401 is released, and the threshold value.

For example, the processor 520 may determine an increased threshold value (e.g., second threshold value) based on the largest value among the quality of a signal measured at or before the time when a situation of performing data transmission and/or reception via short-range wireless communication is switched to a situation of performing data transmission and/or reception via cellular wireless communication, the quality of a signal measure at or before the time when it is determined that a response message corresponding to an ARP request message is not received, the quality of a signal measured at or before the time when the connection between the electronic device 100 and the AP 401 is released, and the threshold value. For example, the processor 520 may determine (or configure), as the increased threshold value (e.g., second threshold value), a value obtained by adding a predetermined value to the largest value among an RSSI value of a signal measured at or before the time when a situation of performing data transmission and/or reception via short-range wireless communication is switched to a situation of performing data transmission and/or reception via cellular wireless communication, an RSSI value of a signal measure at or before the time when it is determined that a response message corresponding to an ARP request message is not received, an RSSI value of a signal measured at or before the time when the connection between the electronic device 100 and the AP 401 is released, and the threshold value. The processor 520 may determine the increased threshold value by using the following Equation 1.

RSSI_{change}=max(RSSI₁,RSSI₂,RSSI₃,RSSI_{original})+Threshold [Equation 1]

(RSSI_{change}: Changed threshold value (second threshold value), RSSI₁: an RSSI value of a signal measured at or before the time of switch to a situation of performing data transmission and/or reception via cellular wireless communication, RSSI₂: an RSSI value of a signal measure at or before the time when it is determined that a response message corresponding to an ARP request message is not received, RSSI₃: an RSSI value of a signal measured at or before the time when the connection between the electronic device 100 and the AP 401 is released, RSSI_{original}: a threshold value before change (first threshold value), Threshold: a predetermined value)

The threshold value may be configured for each frequency band supported by the electronic device 100 or the communication circuitry 510. According to an example, when the electronic device 100 or the communication circuitry 510 supports a first frequency band (e.g., 2.4 GHz), a second frequency band (e.g., 5 GHZ), and/or a third frequency band (e.g., 6 GHZ), the processor 520 may configure a threshold value corresponding to the first frequency band, a threshold value corresponding to the second frequency band, and a threshold value corresponding to the third frequency band, respectively, and may change the same, respectively. According to an example, when the electronic device 100 is connected to the AP 401 via the second frequency band, the processor 520 may increase the threshold value corresponding to the second frequency band, and may maintain the threshold value corresponding to the first frequency band and the threshold value corresponding to the third frequency band.

Alternatively, the threshold value may be configured for each AP 401. According to an example, the processor 520 may increase (or change) the threshold value corresponding to the AP 401 among threshold values respectively corresponding to a plurality of APs connectable to the electronic device 100. In addition, the processor 520 may maintain the threshold values respectively corresponding to the APs, except for the AP 401, among the plurality of APs connectable to the electronic device 100. The processor 520 may store and manage the threshold values of the plurality of APs connectable to the electronic device 100 in the memory 530. According to an example, the processor 520 may store and manage threshold values using a table implemented as shown in Table 1 below. The processor 520 may store and manage both a threshold value before being increased and an increased threshold value, and the threshold value before being increased may be used in a threshold restoration process to be described below.

TABLE 1

| AP (or BSSID) | Threshold value |
|---|---|
| AP (401) | −40 |
| Second AP | −50 |
| Third AP | −35 |

The processor 520 may increase a threshold value and then change the threshold value to a previous threshold value. Changing the threshold value to the previous threshold value may refer to the process in which the processor 520 changes the threshold value for releasing the connection between the electronic device 100 and the AP 401 from the second threshold value to the first threshold value. When the threshold value is configured for each frequency band available to the electronic device 100, maintaining the increased threshold may hinder a connection of another AP or a connection of the AP 401 having improved quality. Therefore, the processor 520 may change the threshold value again according to satisfaction of an appropriate condition, such that the electronic device 100 may smoothly connect to the AP 401 in a situation where the electronic device 100 may perform short-range wireless communication.

According to an example, the processor 520 may identify (or monitor) a movement distance of the electronic device 100, and reduce the increased threshold value (or change the increased threshold value to the previous threshold value) based on identifying that the movement distance of the electronic device 100 is greater than or equal to a predetermined distance. When the movement distance of the electronic device 100 is greater than or equal to the predetermined distance, there is a possibility that the distance between the electronic device 100 and the AP 401 may be decreased, and the decrease in the distance between the electronic device 100 and the AP 401 may indicate a situation in which the quality of the short-range wireless communication provided by the AP 401 may be increased. Alternatively, when the movement distance of the electronic device 100 is greater than or equal to the predetermined distance, the electronic device 100 may have a possibility of discovering another AP that is capable of providing appropriate short-range wireless communication. Therefore, the processor 520 may reduce the increased threshold value (or reconfigure the threshold value to the previous threshold value), based on the movement distance of the electronic device 100 being greater than or equal to the predetermined distance.

The processor 520 may take into consideration a parameter similar to the movement distance of the electronic device 100. For example, the processor 520 may identify (or monitor) the body information of a user of the electronic device 100, and the processor 520 may increase the threshold value, and then, may decrease the increased threshold value (or change the increased threshold value back to the previous threshold value) based on the number of steps of the user of the electronic device 100 being greater than or equal to a predetermined number of steps.

The processor 520 may reduce the increased threshold value (or change the increased threshold value to the previous threshold value) when search (or discovery) for another AP connectable via the short-range wireless communication is successful.

When the AP 401 is not discovered, or when the number of times the AP 401 is not discovered is greater than or equal to (or exceeds) a predetermined number, the processor 520 may decrease the increased threshold value (or change the increased threshold value to the previous threshold value).

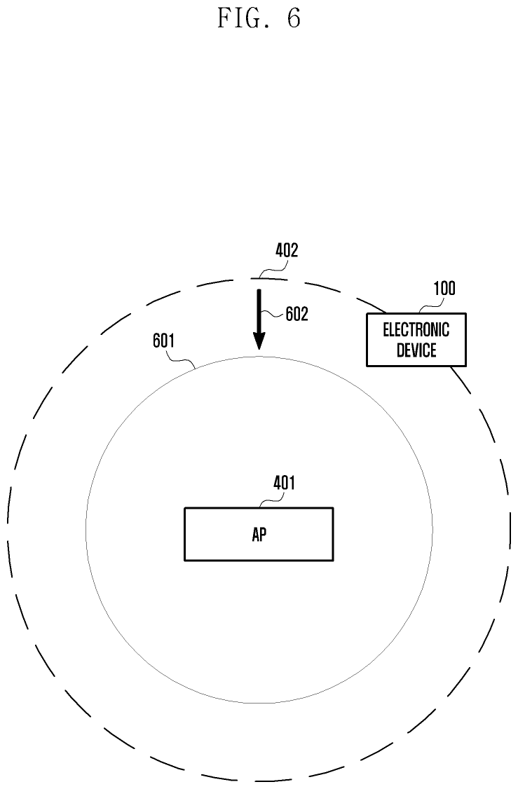

FIG. 6 is a diagram illustrating an example in which an electronic device increases a threshold representing a minimum value of quality required for short-range wireless communication according to an embodiment.

An electronic device (e.g., the electronic device 100 in FIG. 5) may perform the link setup operation described in FIG. 3, and be connected to the access point (AP) 401 (e.g., the AP 401 in FIG. 4) via short-range wireless communication. The electronic device 100 may transmit and/or receive data to/from an entity outside the AP 401 via the short-range wireless communication provided by the AP 401. According to an example, the electronic device 100 may perform a role of an STA defined in IEEE 802.11.

In order to connect to the AP 401, the electronic device 100 may perform a procedure of discovering (or scanning) the AP 401 connectable to the electronic device 100. The electronic device 100 may receive a signal received or broadcast from the AP 401, and identify whether the quality of the signal satisfies a predetermined condition. The electronic device 100 may be connected to the AP 401 via short-range wireless communication, when the quality of the signal satisfies the predetermined condition. The signal quality may be expressed as a received signal received power (RSRP) or a received signal strength indicator (RSSI) of the signal. According to an example, the designated condition may include a condition in which the quality of a signal is greater than or equal to a threshold value. The threshold value may refer to a value representing a minimum quality of the AP 401 connectable to the electronic device 100. According to an example, the threshold value may be referred to as various names meaning a value representing a minimum quality of a signal. For example, the threshold value may be defined as an entry RSSI. The electronic device 100 may be connected to the AP 401 via short-range wireless communication, based on the quality of a signal received from the AP 401 being greater than or equal to the threshold value.

According to an example, when the electronic device 100 is connected to the AP 401 via the short-range wireless communication, the electronic device 100 may transmit data to an external device via the short-range wireless communication, and may receive data transmitted by the external device via the short-range wireless communication.

However, the electronic device 100 is a mobile device, and the position of the electronic device 100 may be changed. Referring to FIG. 6, the electronic device 100 may move to the position 402 where the quality of a signal received from the AP 401 may be measured to be the threshold value or a value substantially equal to the threshold value.

When the electronic device 100 is located outside the position 402 where the quality of a signal received from the AP 401 is measured to be the threshold value or a value substantially equal to the threshold value, it may be difficult to perform short-range wireless communication provided by the AP 401. The electronic device 100 may release the short-range wireless communication between the electronic device 100 and the AP 401, and transmit and/or receive data via cellular wireless communication. However, when the electronic device 100 is located in the position 402 where the quality of a signal received from the AP 401 may be measured to be the threshold value or a value substantially equal to the threshold value, the connection between the electronic device 100 and the AP 401 may be repeatedly released and reconnected due to an error in measuring the quality of a signal.

According to an example, in the case of transmitting data, the electronic device 100 may perform a procedure of acquiring an address (e.g., a MAC address) of an external device that is to receive the data. The electronic device 100 may transmit, through the AP 401 or to a gateway connected to the AP 401, a message (e.g., an ARP request message) including an IP address of the external device. In case that the AP 401 also performs a role of a gateway, the electronic device 100 may transmit an ARP request message to the AP 401. The AP 401 or the gateway may receive the ARP request message and identify the IP address of the external device included in the ARP request message. The AP 401 or the gateway may acquire a medium access control (MAC) address corresponding to the IP address of the external device, and transmit an ARP response message including the MAC address of the external device to the electronic device 100. The electronic device 100 may transmit data to the external device via the short-range wireless communication by using the MAC address of the external device included in the ARP response message.

According to an example, as the electronic device 100 moves to the position 402 where the quality of a signal received from the AP 401 is measured to be the threshold value or a value substantially the same as the threshold value, the quality of the short-range wireless communication may be degraded. The AP 401 may be unable to receive the ARP request message, and therefore, may be unable to transmit the ARP response message to the electronic device 100. Although the AP 401 receives the ARP request message and transmits the ARP response message, the electronic device 100 may be unable to receive the same. When the ARP response message is not received, the electronic device 100 may be unable to obtain the MAC address of the external device with which data transmission and/or reception is to be performed, and may be unable to perform short-range wireless communication. However, the electronic device 100 may be in a state where the connection with the AP 401 is not released.

The electronic device 100 may perform a process of reacquiring (or updating) the IP address of the electronic device 100 when the ARP response message is not received. In order to reacquire (or update) the IP address of the electronic device 100, the electronic device 100 may transmit a DHCP request message to the AP 401 or the gateway connected to the AP 401. When a DHCP response message is not received within a defined time, the electronic device 100 may release the connection between the electronic device 100 and the AP 401 and increase the threshold value.

The electronic device 100 may, based on a beacon signal not being received from the AP 401 within a defined time, release the connection between the electronic device 100 and the AP 401 via short-range wireless communication, and increase the threshold value from a first threshold value to a second threshold value.

The electronic device 100 may increase the threshold value, based on the number of releases and re-establishments of the connection between the electronic device 100 and the AP 401 being greater than or equal to a predetermined number.

An increase in the threshold value may indicate an operation of reducing a possibility that the electronic device 100 and the AP 401 may be connected via the short-range wireless communication. The larger the threshold value, the higher the quality of a signal received from the AP 401 may be required for the electronic device 100 and the AP 401 to be connected via short-range wireless communication.

Referring to FIG. 6, as the threshold value is increased, coverage 601 of the AP 401 may become smaller than coverage 402 before the increase in the threshold value (602).

The electronic device 100 may refrain from establishing the connection between the electronic device 100 and the AP 401 by increasing the threshold value, and may prevent (or reduce) inconvenience of a user caused by attempting to connect to the AP 401 and connecting to the AP 401 even in a state in which the electronic device 100 has difficulty in performing short-range wireless communication.

According to an example, the electronic device 100 may increase the threshold value, identify the quality of a signal received from the AP 401, and, based on identifying that the quality of the signal is lower than the increased threshold value, refrain from establishing, or prevent, the connection between the AP 401 and the electronic device 100.

Through the method described above, the electronic device 100 may reduce (or prevent) a phenomenon in which the connection between the electronic device 100 and the AP 401 is repeatedly released and reconnected by increasing the threshold value.

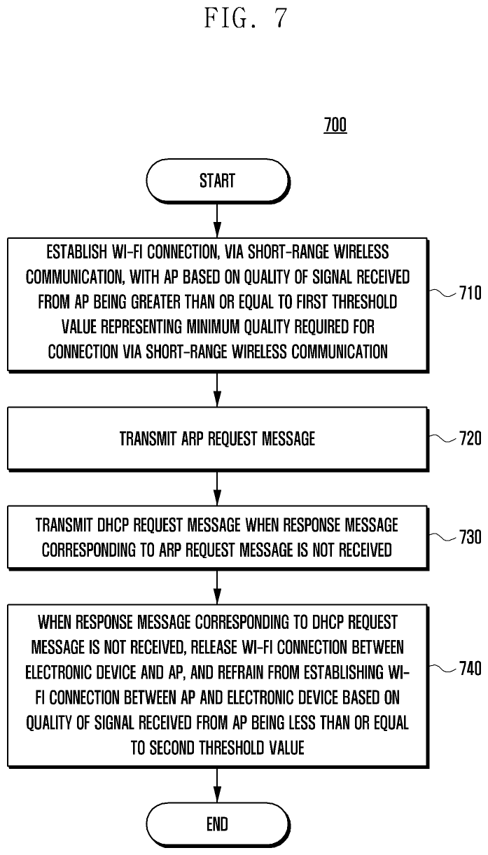

FIG. 7 is a flowchart 700 illustrating an operation method of an electronic device according to an embodiment.

The electronic device (e.g., the electronic device 100 in FIG. 5) may establish a Wi-Fi connection via short-range wireless communication with an AP (e.g., the AP 401 in FIG. 4) based on the quality of a signal received from the AP 401 being greater than or equal to a first threshold value representing a minimum value of quality required for connection via short-range wireless communication, in operation 710.

The electronic device 100 may control the communication circuitry 510 to discover an AP (e.g., the AP 401 in FIG. 4) capable of providing short-range wireless communication, in order to perform short-range wireless communication. In order to discover the AP 401, the electronic device 100 may control the communication circuitry 510 to broadcast a probe request message. The probe request message may include information associated with the electronic device 100. According to an example, the probe request message may include various identification information (e.g., a MAC address) for distinguishing the electronic device 100 from other electronic devices, and performance information related to the short-range wireless communication of the electronic device 100. When the AP 401 receives the probe request message, the AP 401 may transmit a probe response message corresponding to the probe request message to the electronic device 100. The electronic device 100 may successfully discover the AP 401 when the probe response message is received.

According to another example, the electronic device 100 may successfully discover the AP 401 by receiving a beacon signal broadcast by the AP 401.

The electronic device 100 may identify the quality of the signal (e.g., the beacon signal broadcast by the AP 401 or the probe response message transmitted by the AP 401) received from the AP 401. The electronic device 100 may identify whether the quality of the signal satisfies a predetermined condition. The electronic device 100 may be connected to the AP 401 via short-range wireless communication, when the signal quality satisfies the predetermined condition. The signal quality may be expressed as a received signal received power (RSRP) or a received signal strength indicator (RSSI) of the signal. According to an example, the predetermined condition may include a condition in which the quality of a signal is greater than or equal to a threshold value. The threshold value may refer to a value representing a minimum quality of the AP 401 connectable to the electronic device 100. According to an example, the threshold value may be referred to as various names representing a minimum quality of a signal. For example, the threshold value may be defined as an entry RSSI. The electronic device 100 may be connected to the AP 401 via short-range wireless communication, based on the quality of the signal received from the AP 401 being greater than or equal to the first threshold value.

The electronic device 100 may establish a Wi-Fi connection via short-range wireless communication with the discovered AP 401, based on the quality of the signal received from the AP 401 being greater than or equal to the first threshold value. As described in FIG. 3, the electronic device 100 may perform an authentication procedure with the discovered AP 401, an association procedure with the AP 401, and/or a security setup procedure with the AP 401. The electronic device 100 may complete the above procedures and connect to the AP 401. The connection via the short-range wireless communication between the electronic device 100 and the AP 401 may be referred to as a Wi-Fi connection.

The electronic device 100 may perform a dynamic host configuration protocol (DHCP) procedure, which is a procedure for acquiring an IP address required for the electronic device 100 to perform short-range wireless communication, as part of the procedure of connecting to the AP 401. The electronic device 100 may perform the DHCP procedure so as to be assigned an IP address. In the DHCP procedure, the electronic device 100 transmits a DHCP discovery message to the AP 401 to discover a DHCP server capable of allocating an

IP address to the electronic device 100. The AP 401 may transfer the DHCP discovery message transmitted by the electronic device 100 to the DHCP server, and, upon receiving the DHCP discovery message, the DHCP server may transmit a DHCP offer message including an IP address available to the electronic device 100 and a configuration parameter to the electronic device 100 through the AP 401. Based on the DHCP offer message, the electronic device 100 may transmit a DHCP request message including the IP address to be used by the electronic device 100 to the AP 401. Upon receiving the DHCP request message, the DHCP server may transmit a response message to the electronic device 100. Although it is described that the AP 401 and the DHCP server are implemented separately in the above description, the AP 401 may perform the role of the DHCP server, concurrently.

The electronic device 100 may be assigned the IP address of the electronic device 100 through the above-described method, and may perform short-range wireless communication using the IP address.

According to an example, when the electronic device 100 is connected to the AP 401 via short-range wireless communication, the electronic device 100 may transmit data to an external device via the short-range wireless communication and may receive data transmitted by the external device via the short-range wireless communication.

The electronic device 100 may transmit an ARP request message to the AP 401 in operation 720.

According to an example, in the case of transmitting data, the electronic device 100 may perform a procedure for acquiring an address (e.g., a MAC address) of an external device that is to receive the data. The electronic device 100 may transmit a message (e.g., an ARP request message) including an IP address of the external device through the AP 401, or to a gateway connected to the AP 401. When the AP 401 also performs the role of a gateway, the electronic device 100 may transmit the ARP request message to the AP 401. The electronic device 100 may transmit the ARP request message to the AP 401 after completing the establishment of the Wi-Fi connection to the AP 401. The AP 401 or the gateway may receive the ARP request message and identify the IP address of the external device included in the ARP request message. The AP 401 or gateway may acquire a medium access control (MAC) address corresponding to the IP address of the external device, and may transmit an ARP response message including the MAC address of the external device to the electronic device 100. The electronic device 100 may transmit data to the external device via short-range wireless communication by using the MAC address of the external device included in the ARP response message.

The electronic device 100 may control the communication circuitry 510 to transmit the ARP request message to the AP 401. However, the electronic device 100 may be unable to receive the ARP response message corresponding to the ARP request message.

According to an example, as the electronic device 100 moves to the position 402 where the quality of a signal received from the AP 401 is measured to be a threshold value or a value substantially the same as the threshold value, the quality of short-range wireless communication may be degraded. The AP 401 may be unable to receive the ARP request message, and therefore may be unable to transmit the ARP response message to the electronic device 100. Alternatively, although the AP 401 receives the ARP request message and transmits the ARP response message, the electronic device 100 may be unable to receive the same. When the ARP response message is not received, the electronic device 100 may be unable to obtain the MAC address of the external device with which data transmission and/or reception is to be performed, and may be unable to perform short-range wireless communication. However, the electronic device 100 may be in a state where the connection with the AP 401 is not released.

The electronic device 100 may transmit a DHCP request message to the AP 401 when a response message corresponding to the ARP request message is not received, in operation 730.

When the ARP response message, which is a response message corresponding to the ARP request message is not received by the electronic device 100, the electronic device 100 may determine whether to release the connection between the electronic device 100 and the AP 401 and whether to increase (or change) the threshold value from the first threshold value to a second threshold value as follows.

When the ARP response message is not received, the electronic device 100 may perform a procedure for reacquiring (or updating) the IP address of the electronic device 100. In order to reacquire (or update) the IP address of the electronic device 100, the electronic device 100 may transmit the DHCP request message to the AP 401 or the gateway connected to the AP 401.

When the AP 401 receives the DHCP request message, the AP 401 may attempt to transmit a DHCP response message corresponding to the DHCP request message to the electronic device 100. The DHCP response message may include an IP address available to the electronic device 100. When the DHCP response message is received within a defined time, the electronic device 100 may maintain the connection between the electronic device 100 and the AP 401 and maintain the threshold value. Receiving the DHCP response message within the defined time may indicate that the quality of a channel between the electronic device 100 and the AP 401 is at a level capable of performing short-range wireless communication. In other words, non-reception of the ARP response message may be a temporary error.

In operation 740, the electronic device 100 may, when the response message corresponding to the DHCP request message is not received, release the connection between the electronic device 100 and the AP 401, and based on the quality of a signal received from the AP 401 being a second threshold value greater than the first threshold value, refrain from establishing the connection to the AP 401.

When the DHCP response message is not received within the defined time, the electronic device 100 may release the connection between the electronic device 100 and the AP 401 and increase the threshold value from the first threshold value to the second threshold value.

The situation in which the DHCP response message is not received within the defined time, it may indicate that the quality of the channel between the electronic device 100 and the AP 401 is in a state insufficient for performing short-range wireless communication. Therefore, the electronic device 100 may release the connection between the electronic device 10 and the AP 401, and transmit and/or receive data through another wireless communication (e.g., cellular wireless communication or short-range wireless communication provided by another AP) other than the short-range wireless communication provided by the AP 401, thereby reducing a degradation in the quality of a service using the transmitted and/or received data.

Upon identifying that the DHCP response message is not received within the defined time, the electronic device 100 may change the threshold value. According to an example, when the DHCP response message is not received within the defined time, the electronic device 100 may increase the threshold value.

An increase in the threshold value may indicate an operation of decreasing a possibility that the electronic device 100 and the AP 401 may be connected via the short-range wireless communication. The larger the threshold value, the higher the quality of a signal received from the AP 401 is required for the electronic device 100 and the AP 401 to be connected via short-range wireless communication.

For example, when the quality of a signal received from the AP 401 has the first threshold value higher than the threshold value, the electronic device 100 may be connected to the AP 401 via short-range wireless communication. When the electronic device 100 changes the threshold value to be higher than the first threshold value, the electronic device 100 may not connect to the AP 401.

The electronic device 100 may refrain from establishing the connection between the electronic device 100 and the AP 401 by increasing the threshold value, and may prevent (or reduce) the user's inconvenience of attempting to connect to the AP 401 and connecting to the AP 401 even in a state in which the electronic device 100 has difficulty in performing short-range wireless communication.

According to an example, the electronic device 100 may increase the threshold value, identify the quality of a signal received from the AP 401, and refrain from establishing, or prevent, the connection between the AP 401 and the electronic device 100, based on identifying that the quality of the signal is lower than the increased threshold value.

Through the above-described method, the electronic device 100 may reduce (or prevent) a phenomenon in which the connection between the electronic device 100 and the AP 401 is repeatedly released and reconnected by increasing the threshold value.

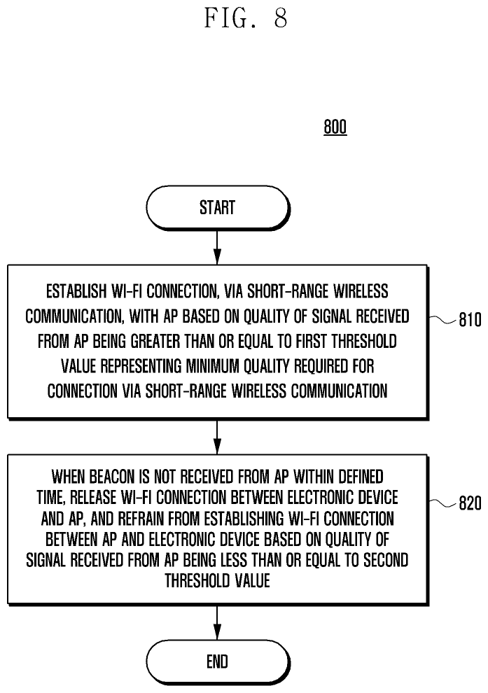

FIG. 8 is a flowchart illustrating an operation method of an electronic device according to an embodiment.

An electronic device (e.g., the electronic device 100 in FIG. 5) may establish a Wi-Fi connection via short-range wireless communication with an AP (e.g., the AP 401 in FIG. 4) based on the quality of a signal received from the AP 401 being greater than or equal to a first threshold value representing a minimum value of quality required for connection via short-range wireless communication, in operation 810.

In order to perform short-range wireless communication, the electronic device 100 may control the communication circuitry 510 to discover an AP (e.g., the AP 401 in FIG. 4) capable of providing short-range wireless communication. In order to discover the AP 401, the electronic device 100 may control the communication circuitry 510 to broadcast a probe request message. The probe request message may include information associated with the electronic device 100. According to an example, the probe request message may include various identification information (e.g., a MAC address) for distinguishing the electronic device 100 from other electronic devices, and performance information associated with the short-range wireless communication of the electronic device 100. When the AP 401 receives the probe request message, the AP 401 may transmit, to the electronic device 100, a probe response message corresponding to the probe request message. The electronic device 100 may successfully discover the AP 401 when the probe response message is received.

According to another example, the electronic device 100 may successfully discover the AP 401 by receiving a beacon signal broadcast by the AP 401.

The electronic device 100 may identify the quality of the signal (e.g., the beacon signal broadcast by the AP 401 or the probe response message transmitted by the AP 401) received from the AP 401. The electronic device 100 may identify whether the signal quality satisfies a predetermined condition. When the signal quality satisfies the predetermined condition, the electronic device 100 may be connected to the AP 401 via short-range wireless communication. The quality of the signal may be expressed as, for example, a received signal received power (RSRP) or a received signal strength indicator (RSSI) of the signal. According to an example, the predetermined condition may include a condition in which the quality of a signal is greater than or equal to (or exceeds) a threshold value. The threshold value may refer to a value representing a minimum quality of the AP 401 connectable to the electronic device 100. According to an example, the threshold value may be referred to as various names indicating the minimum quality of a signal. For example, the threshold value may be defined as an entry RSSI. The electronic device 100 may be connected to the AP 401 via short-range wireless communication, based on the quality of the signal received from the AP 401 being greater than or equal to (or exceeding) the threshold value.

The electronic device 100 may perform a procedure of connecting to the discovered AP 401 via short-range wireless communication, based on the quality of the signal received from the AP 401 being greater than or equal to (or exceeding) the threshold value. As described in FIG. 3, the electronic device 100 may perform an authentication procedure with the discovered AP 401, an association procedure with the AP 401, and/or a security setup procedure with the AP 401. The electronic device 100 may complete the above-described procedures and connect to the AP 401.

The electronic device 100 may perform a dynamic host configuration protocol (DHCP) procedure, which is a procedure of acquiring an IP address required for the electronic device 100 to perform short-range wireless communication, as part of the procedure of connecting to the AP 401. The electronic device 100 may perform a DHCP procedure so as to be assigned an IP address. In the DHCP procedure, the electronic device 100 may transmit a DHCP discovery message to the AP 401 to discover a DHCP server capable of allocating an IP address to the electronic device 100. The AP 401 may transfer the DHCP discovery message transmitted by the electronic device 100 to the DHCP server, and, upon receiving the DHCP discovery message, the DHCP server may transmit a DHCP offer message including an IP address available to the electronic device 100 and a configuration parameter to the electronic device 100 through the AP 401. Based on the DHCP offer message, the electronic device 100 may transmit, to the AP 401, a DHCP request message including the IP address to be used by the electronic device 100. Upon receiving the DHCP request message, the DHCP server may transmit a response message to the electronic device 100. In the above description, although it is described that the AP 401 and the DHCP server are separately implemented, the AP 401 may perform the role of the DHCP server, concurrently.

The electronic device 100 may be assigned the IP address of the electronic device 100 through the method described above, and perform short-range wireless communication using the IP address.

According to an example, when the electronic device 100 is connected to the AP 401 via the short-range wireless communication, the electronic device 100 may transmit data to an external device via the short-range wireless communication, and may receive data transmitted from the external device via the short-range wireless communication.

In operation 820, when a beacon is not from the AP 401 within a defined time, the electronic device 100 may release the connection between the electronic device 100 and the AP 401, and based on the quality of a signal received from the AP 401 being a second threshold value greater than the first threshold value, may refrain from establishing the connection between the AP 401 and the electronic device 100.

According to an example, the electronic device 100 may receive a beacon signal from the AP 401 at a predetermined cycle. However, as a distance between the electronic device 100 and the AP 401 increases, the electronic device 100 may be unable to receive a beacon signal from the AP 401.

Based on a beacon signal not being received from the AP 401 within the defined time, the electronic device 100 may release the connection via the short-range wireless communication between the electronic device 100 and the AP 401 and increase the threshold value. The defined time may be a multiple of a transmission period of a beacon transmitted by the AP 401, but is not limited thereto. The defined time may be changed according to the characteristics of a service performed by the electronic device 100. For example, when the electronic device 100 is performing a service requiring a low delay time, the defined time may be reduced. Alternatively, when performing a background service, the electronic device 100 may configure the defined time to be longer.

The situation in which a beacon signal is not received from the AP 401 within the defined time may indicate that the quality of a channel between the electronic device 100 and the AP 401 is in a state insufficient for performing short-range wireless communication. Therefore, the electronic device 100 may release the connection between the electronic device 100 and the AP 401 and transmit and/or receive data via another wireless communication (e.g., cellular wireless communication or short-range wireless communication provided by another AP) instead of the short-range wireless communication provided by the AP 401, thereby reducing the degradation of the quality of a service using the transmitted and/or received data.

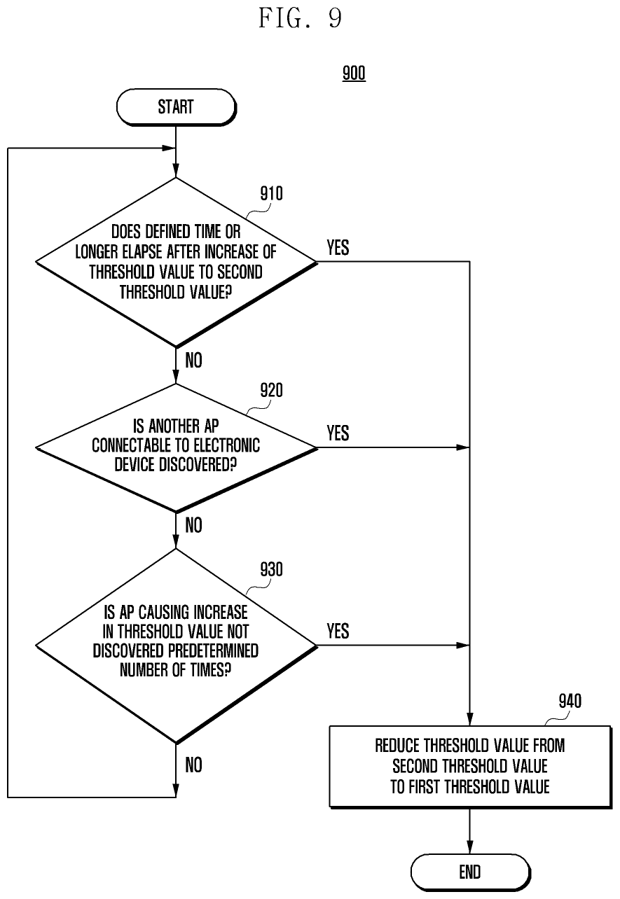

FIG. 9 is a flowchart 900 illustrating an operation method of an electronic device according to an embodiment.

The electronic device (e.g., the electronic device 100 in FIG. 5) may increase a threshold value from a first threshold value to a second threshold value and then identify whether a defined time or longer elapses, in operation 910.

Upon identifying that the defined time or longer elapses after increasing the threshold value (Yes in operation 910), the electronic device 100 may decrease the threshold value from the second threshold value to the first threshold value in operation 940.

Upon identifying that the defined time or longer does not elapse after increasing the threshold value (No in operation 910), the electronic device 100 may identify whether another AP connectable to the electronic device 100 is discovered in operation 920.

When it is identified that another AP connectable to the electronic device 100 is discovered (Yes in operation 920), the electronic device 100 may reduce the threshold value from the second threshold value to the first threshold value in operation 940.

When another AP connectable to the electronic device 100 is not discovered (No in operation 920), the electronic device 100 may identify whether the AP 401 causing the increase in the threshold value is not discovered a predetermined number of times, in operation 930.

When the AP 401 that causes the increase in the threshold value has been discovered at least once (No in operation 930), the electronic device 100 may maintain the increased threshold value.

When the AP 401 that causes the increase in the threshold value is not discovered the predetermined number of times, the electronic device 100 may decrease the threshold value from the second threshold value to the first threshold value in operation 940.

An electronic device according to an example may include communication circuitry for performing short-range wireless communication. The electronic device may include memory for storing instructions. The electronic device may include at least one processor. The instructions, when executed by the at least one processor, may cause the electronic device to establish a Wi-Fi connection, via short-range wireless communication, with an access point (AP) based on the quality of a signal received from the AP being greater than or equal to a first threshold value representing a minimum value of quality required for connection via the short-range wireless communication. The instructions, when executed by the at least one processor, may cause the electronic device to transmit an address resolution protocol (ARP) request message to the AP after establishing the Wi-Fi connection to the AP. The instructions, when executed by the at least one processor, may cause the electronic device to transmit a dynamic host configuration protocol (DHCP) request message to the AP to acquire an internet protocol (IP) address of the electronic device, when a response message corresponding to the ARP request message is not received from the AP within a defined time. The instructions, when executed by the at least one processor, may cause the electronic device to, in a case where a response message corresponding to the DHCP request message is not received from the AP within a defined time, release the Wi-Fi connection between the electronic device and the AP, and refrain from establishing the Wi-Fi connection between the AP and the electronic device, based on the quality of a signal received from the AP being less than a second threshold value that is greater than the first threshold value.

In the electronic device according to an example, the instructions, when executed by the at least one processor, may cause the electronic device to refrain from transmitting a signal for requesting the establishment of the Wi-Fi connection between the AP and the electronic device, based on the quality of a signal received from the AP being less than or equal to the second threshold value.

In the electronic device according to an example, the second threshold value may be greater than one of: an received signal strength indicator (RSSI) value of a signal received from the AP, which is measured during activation of cellular wireless communication; an RSSI value of a signal measured when the response message corresponding to the ARP request message is not received; an RSSI value of a signal measured when the Wi-Fi connection between the electronic device and the AP is released; and the first threshold value.

In the electronic device according to an example, the instructions, when executed by the at least one processor, may cause the electronic device to release the Wi-Fi connection between the electronic device and the AP, and increase a threshold value for releasing the connection between the electronic device and the AP from the first threshold value to the second threshold value, based on a beacon not being received from the AP.

In the electronic device according to an example, the instructions, when executed by the at least one processor, may cause the electronic device to increase the threshold value from the first threshold value to the second threshold value, based on the number of releases and re-establishments of the Wi-Fi connection between the electronic device and the AP being greater than or equal to a predetermined number.

In the electronic device according to an example, the instructions, when executed by the at least one processor, may cause the electronic device to decrease the threshold value from the second threshold value to the first threshold value, based on detecting that a movement distance of the electronic device is greater than or equal to a predetermined distance.

In the electronic device according to an example, the instructions, when executed by the at least one processor, may cause the electronic device to reduce the threshold value from the second threshold value to the first threshold value, based on another AP being discovered by the electronic device and/or the AP not being discovered.

In the electronic device according to an example, the threshold value may be set differently for each frequency band available to the electronic device.

In the electronic device according to an example, the threshold value may be set differently for each AP connectable to the electronic device.

In a recording medium storing at least one program including instructions which, when executed individually or collectively by at least one processor of an electronic device, cause the electronic device to perform operations, the instructions, when executed by the at least one processor, may cause the electronic device to establish a Wi-Fi connection, via short-range wireless communication, with an access point (AP) based on the quality of a signal received from the AP being greater than or equal to a threshold value representing a minimum value of quality required for connection via the short-range wireless communication. The instructions, when executed by the at least one processor, may cause the electronic device to transmit an address resolution protocol (ARP) request message to the AP after establishing the Wi-Fi connection to the AP. The instructions, when executed by the at least one processor, may cause the electronic device to transmit a dynamic host configuration protocol (DHCP) request message to the AP to acquire an internet protocol (IP) address of the electronic device, when a response message corresponding to the ARP request message is not received from the AP within a defined time. The instructions, when executed by the at least one processor, may cause the electronic device to, in a case where a response message corresponding to the DHCP request message is not received from the AP within a defined time, release the Wi-Fi connection between the electronic device and the AP, and refrain from establishing the Wi-Fi connection between the AP and the electronic device, based on the quality of a signal received from the AP being less than a second threshold value that is greater than the first threshold value.

In the recording medium according to an example, the instructions, when executed by the at least one processor, may cause the electronic device to refrain from transmitting a signal for requesting establishment of the Wi-Fi connection between the AP and the electronic device, based on the quality of a signal received from the AP being less than or equal to the second threshold value.

In the recording medium according to an example, the second threshold value may be greater than one of: an received signal strength indicator (RSSI) value of a signal received from the AP, which is measured during activation of cellular wireless communication; an RSSI value of a signal measured when the response message corresponding to the ARP request message is not received; an RSSI value of a signal measured when the Wi-Fi connection between the electronic device and the AP is released; and the first threshold value.

In the recording medium according to an example, the instructions, when executed by the at least one processor, may cause the electronic device to release the Wi-Fi connection between the electronic device and the AP, and increase a threshold value for releasing the connection between the electronic device and the AP from the first threshold value to the second threshold value, based on a beacon not being received from the AP.

In the recording medium according to an example, the instructions, when executed by the at least one processor, may cause the electronic device to increase the threshold value from the first threshold value to the second threshold value, based on the number of releases and re-establishments of the Wi-Fi connection between the electronic device and the AP being greater than or equal to a predetermined number.

In the recording medium according to an example, the instructions, when executed by the at least one processor, may cause the electronic device to decrease the threshold value from the second threshold value to the first threshold value, based on detecting that a movement distance of the electronic device is greater than or equal to a predetermined distance.

In the recording medium according to an example, the instructions, when executed by the at least one processor, may cause the electronic device to reduce the threshold value from the second threshold value to the first threshold value, based on another AP being discovered by the electronic device and/or the AP not being discovered.

An operation method of an electronic device according to an example may include an operation of establishing a Wi-Fi connection, via short-range wireless communication, with an access point (AP) based on the quality of a signal received from the AP being greater than or equal to a first threshold value representing a minimum value of quality required for connection via the short-range wireless communication. The operation method of the electronic device may include an operation of transmitting an address resolution protocol (ARP) request message to the AP, after connecting to the AP. The operation method of the electronic device may include an operation of transmitting, to the AP, a dynamic host configuration protocol (DHCP) request message for acquiring an Internet Protocol (IP) address of the electronic device when a response message corresponding to the ARP request message is not received from the AP within a defined time. The operation method of the electronic device may include an operation of releasing the Wi-Fi connection between the electronic device and the AP when a response message corresponding to the DHCP request message is not received from the AP within a defined time, and refraining from establishing the connection between the AP and the electronic device, based on the quality of a signal received from the AP being less than a second threshold value greater than the first threshold value.

The operation method of the electronic device according to an example may further include an operation of refraining from transmitting a signal for requesting establishment of the Wi-Fi connection between the AP and the electronic device, based on the quality of a signal received from the AP being less than or equal to the second threshold value.

The operation method of the electronic device according to an embodiment, the second threshold value may be greater than one of: an received signal strength indicator (RSSI) value of a signal received from the AP, which is measured during activation of cellular wireless communication; an RSSI value of a signal measured when the response message corresponding to the ARP request message is not received; an RSSI value of a signal measured when the Wi-Fi connection between the electronic device and the AP is released; and the first threshold value.

The operation method of the electronic device according to an example may further include an operation of releasing the Wi-Fi connection between the electronic device and the AP, and increasing a threshold value for releasing the connection between the electronic device and the AP from the first threshold value to the second threshold value, based on a beacon not receiving from the AP.

An electronic device according to an example may include communication circuitry for performing short-range wireless communication. The electronic device may include memory for storing instructions. The electronic device may include at least one processor. The instructions, when executed by the at least one processor, may cause the electronic device to establish a Wi-Fi connection, via the short-range wireless communication, with an access point (AP) based on the quality of a signal received from the AP being greater than or equal to a first threshold value representing a minimum value of quality required for connection via the short-range wireless communication. The instructions, when executed by the at least one processor, may cause the electronic device to, when a beacon is not received from the AP within a defined time, refrain from establishing the connection between the AP and the electronic device, based on the quality of a signal received from the AP being less than a second threshold value which is greater than the first threshold value.

In the electronic device according to an example, the instructions, when executed by the at least one processor, may cause the electronic device to refrain from transmitting a signal for requesting establishment of the Wi-Fi connection between the AP and the electronic device, based on the quality of a signal received from the AP being less than or equal to the second threshold value.

In the electronic device according to an example, the instructions, when executed by the at least one processor, may cause the electronic device to reduce a threshold value for releasing the connection between the electronic device and the AP from the second threshold value to the first threshold value, based on detecting that a movement distance of the electronic device is greater than or equal to a predetermined distance.

In the electronic device according to an example, the instructions, when executed by the at least one processor, may cause the electronic device to reduce the threshold value from the second threshold value to the first threshold value, based on another AP being discovered by the electronic device and/or the AP not being discovered.

What is claimed is:

1. An electronic device comprising:
communication circuitry configured to perform short-range wireless communication;
memory storing instructions; and
at least one processor,
wherein the instructions, when executed by the at least one processor, cause the electronic device to:
establish a Wi-Fi connection with an access point (AP) via the short-range wireless communication, wherein the Wi-Fi connection is established based on a quality of a signal received from the AP being greater than or equal to a first threshold value, the first threshold value representing a minimum quality for connecting via the short-range wireless communication,
transmit, to the AP, an address resolution protocol (ARP) request message,
based on that a response message corresponding to the ARP request message is not received from the AP within a first defined time period, transmit, to the AP, a dynamic host configuration protocol (DHCP) request message for acquiring an Internet protocol (IP) address of the electronic device, and
based on that a response message corresponding to the DHCP request message is not received from the AP within a second defined time period:
release the Wi-Fi connection between the electronic device and the AP, and
refrain from establishing the Wi-Fi connection between the electronic device and the AP, based on that a quality of the signal received from the AP is less than a second threshold value, wherein the second threshold value is greater than the first threshold value.

2. The electronic device of claim 1, wherein the instructions, when executed by the at least one processor, cause the electronic device to:
refrain from transmitting a request signal for requesting the establishment of the Wi-Fi connection between the AP and the electronic device, based on that a quality of the signal received from the AP is less than or equal to the second threshold value.

3. The electronic device of claim 1, wherein the second threshold value is greater than:
a first received signal strength indicator (RSSI) value of the signal received from the AP, wherein the first RSSI value was measured while cellular wireless communication was activated;
a second RSSI value of the signal measured when the response message corresponding to the ARP request message is not received;
a third RSSI value of the signal measured when the Wi-Fi connection between the electronic device and the AP is released; or
the first threshold value.

4. The electronic device of claim 1, wherein the instructions, when executed by the at least one processor, cause the electronic device to,
based on that a beacon is not received from the AP:
release the Wi-Fi connection between the electronic device and the AP, and
increase a threshold value for releasing the connection between the electronic device and the AP from the first threshold value to the second threshold value.

5. The electronic device of claim 4, wherein the instructions, when executed by the at least one processor, cause the electronic device to:
increase the threshold value from the first threshold value to the second threshold value, based on a number of times of release and re-establishments of the Wi-Fi connection between the electronic device and the AP being greater than or equal to a predetermined number of times.

6. The electronic device of claim 4, wherein the instructions, when executed by the at least one processor, cause the electronic device to:
reduce the threshold value from the second threshold value to the first threshold value, based on detecting that a movement distance of the electronic device is greater than or equal to a predetermined distance.

7. The electronic device of claim 4, wherein the instructions, when executed by the at least one processor, cause the electronic device to:
reduce the threshold value from the second threshold value to the first threshold value, based on the electronic device discovering a different AP and/or being unable to discover the AP.

8. The electronic device of claim 4, wherein the threshold value is differently set for each frequency band supported by the electronic device.

9. The electronic device of claim 4, wherein the threshold value is differently set for each AP connectable to the electronic device.

10. A recording medium storing at least one program including instructions which, when executed by at least one processor of an electronic device individually or collectively, cause the electronic device to perform operations,
wherein the instructions, when executed by the at least one processor, cause the electronic device to:
establish a Wi-Fi connection with an access point (AP) via short-range wireless communication, wherein the Wi-Fi connection is established based on a quality of a signal received from the AP being greater than or equal to a first threshold value, the threshold value representing a minimum quality for connecting via the short-range wireless communication;
transmit, to the AP, an address resolution protocol (ARP) request message;
based on that a response message corresponding to the ARP request message is not received from the AP within a first defined time period, transmit, to the AP, a dynamic host configuration protocol (DHCP) request message for acquiring an Internet protocol (IP) address of the electronic device; and
based on that a response message corresponding to the DHCP request message is not received from the AP within a second defined time period:
release the Wi-Fi connection between the electronic device and the AP, and
based on that a quality of the signal received from the AP is less than a second threshold value greater than the first threshold value, refrain from establishing the connection between the AP and the electronic device.

11. The recording medium of claim 10, wherein the instructions, when executed by the at least one processor, cause the electronic device to:
refrain from transmitting a request signal for requesting the establishment of the Wi-Fi connection between the AP and the electronic device, based on that a quality of the signal received from the AP is less than or equal to the second threshold value.

12. The recording medium of claim 10, wherein the second threshold value is greater than:
a first received signal strength indicator (RSSI) value of the signal received from the AP, wherein the first RSSI was measured while cellular wireless communication was activated;
a second RSSI value of the signal, measured when the response message corresponding to the ARP request message is not received;
a third RSSI value of the signal, measured when the Wi-Fi connection between the electronic device and the AP is released; or
the first threshold value.

13. The recording medium of claim 10, wherein the instructions, when executed by the at least one processor, cause the electronic device to:
based on that a beacon is not received from the AP:
release the Wi-Fi connection between the electronic device and the AP, and
increase a threshold value for releasing the connection between the electronic device and the AP from the first threshold value to the second threshold value.

14. The recording medium of claim 13, wherein the instructions, when executed by the at least one processor, cause the electronic device to:
increase the threshold value from the first threshold value to the second threshold value, based on a number of times of release and re-establishments of the Wi-Fi connection between the electronic device and the AP being greater than or equal to a predetermined number.

15. A method of operating an electronic device, the method comprising:
establishing a Wi-Fi connection with an access point (AP) via the short-range wireless communication, wherein the Wi-Fi connection is established based on a quality of a signal received from an access point (AP) being greater than or equal to a first threshold value, the first threshold value representing a minimum quality for connecting via short-range wireless communication;
transmitting, to the AP, an address resolution protocol (ARP) request message;
based on that a response message corresponding to the ARP request message is not received from the AP within a first defined time period, transmitting, to the AP, a dynamic host configuration protocol (DHCP) request message for acquiring an Internet protocol (IP) address of the electronic device; and
based on that a response message corresponding to the DHCP request message is not received from the AP within a second defined time period:
releasing the Wi-Fi connection between the electronic device and the AP, and
based on that a quality of the signal received from the AP is less than a second threshold value greater than the first threshold value, refraining from establishing the connection between the AP and the electronic device.

16. The method of claim 15, further comprising:
refraining from transmitting a request signal for requesting the establishment of the Wi-Fi connection between the AP and the electronic device, based on that a quality of the signal received from the AP is less than or equal to the second threshold value.

17. The method of claim 16, wherein the second threshold value is greater than:
a first received signal strength indicator (RSSI) value of the signal received from the AP, wherein the first RSSI value was measured while cellular wireless communication was activated;
a second RSSI value of the signal measured when the response message corresponding to the ARP request message is not received;
a third RSSI value of the signal, measured when the Wi-Fi connection between the electronic device and the AP is released; or
the first threshold value.

18. The method of claim 16, further comprising:
based on that a beacon is not received from the AP,
releasing the Wi-Fi connection between the electronic device and the AP, and
increasing a threshold value for releasing the connection between the electronic device and the AP from the first threshold value to the second threshold value.
